(19) United States
(12) Patent Application Publication
(10) Pub. No.: US 2012/0246134 A1
(43) Pub. Date: Sep. 27, 2012

(54) DETECTION AND ANALYSIS OF BACKLINK ACTIVITY

(75) Inventors: Jimmy Yu, Foster City, CA (US); Lemuel S. Park, Cerritos, CA (US); Thomas John Ziola, Menlo Park, CA (US); Albert Marc Gouyet, Palo Alto, CA (US); Lennon Liao, San Mateo, CA (US)

(73) Assignee: Brightedge Technologies, Inc., San Mateo, CA (US)

(21) Appl. No.: 13/424,288

(22) Filed: Mar. 19, 2012

Related U.S. Application Data
(60) Provisional application No. 61/466,383, filed on Mar. 22, 2011.

(51) Int. Cl. G06F 17/30; G06F 15/173

(52) U.S. Cl. 707/706; 709/224; 707/E17.108

(57) ABSTRACT

Systems and methods for detecting and analyzing changes in backlink activity over a period of time are disclosed. For example, the backlinks to web-based content and websites of an entity and/or a competitor of the entity may be monitored over time and changes in the backlinks over time may be determined. Comparison of backlink activity over time may be used to evaluate the backlinks of the competitor to ascertain, group, or otherwise categorize or rank the reasonableness and level of authenticity and actual content value of the backlinks themselves and to determine whether such backlinks are likely to be “black hat” backlinks subject to penalization by search engines.

### CROSS-REFERENCE TO RELATED APPLICATION

This patent application claims priority to and the benefit or U.S. provisional patent application Ser. No. 61/466,383, filed on Mar. 22, 2011, which is incorporated herein by reference.

### BACKGROUND

Backlinks are incoming links to a website or web page. Inbound links were originally important (prior to the emergence of search engines) as a primary means of web navigation; today their significance lies in search engine optimization (SEO). The number of backlinks is one indication of the popularity or importance of that website or page (for example, this is used by Google to determine the PageRank of a web page). Outside of SEO, the backlinks of a web page may be of significant personal, cultural or semantic interest: they indicate who is paying attention to that page.

In basic link terminology, a backlink is any link received by a web node (web page, directory, website, or top level domain) from another web node. Backlinks are also known as incoming links, inbound links, inlinks, and inward links.

Search engines often use the number of backlinks that a website has as one of the most important factors for determining that website's search engine ranking, popularity and importance. Google's description of their PageRank system, for instance, notes that Google interprets a link from page A to page B as a vote, by page A, for page B. Knowledge of this form of search engine rankings has fueled a portion of the SEO industry commonly termed linkspam, where a company attempts to place as many inbound links as possible to their site regardless of the context of the originating site.

Websites often employ various techniques (called search engine optimization, usually shortened to SEO) to increase the number of backlinks pointing to their website. Some methods are free for use by everyone whereas some methods like linkbaiting requires quite a bit of planning and marketing to work. Some websites stumble upon “linkbaiting” naturally; the sites that are the first with a tidbit of ‘breaking news’ about a celebrity are good examples of that. When “linkbait” happens, many websites will link to the ‘baiting’ website because there is information there that is of extreme interest to a large number of people.

There are several factors that determine the value of a backlink. Backlinks from authoritative sites on a given topic are highly valuable. If both sites have content geared toward the keyword topic, the backlink is considered relevant and believed to have strong influence on the search engine rankings of the web page granted the backlink.

Another important factor is the anchor text of the backlink. Anchor text is the descriptive labeling of the hyperlink as it appears on a web page. Search engine bots (i.e., spiders, crawlers, etc.) examine the anchor text to evaluate how relevant it is to the content on a web page. Anchor text and web page content congruency are highly weighted in search engine results page (SERP) rankings of a web page with respect to any given keyword query by a search engine user.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Technologies described herein generally include systems for analyzing changes in backlinks. For example, such systems may be automated to analyze changes in backlinks over time. Such a system may include computer program processing hardware and memory devices having computer program software and computer-executable instructions for performing a computing method that includes examining changes in at least one backlink over a predetermined period of time, processing changes in the at least one backlink over time using an algorithm configured to process large amounts of backlink data across multiple companies in the predetermined period of time and identifying changes in backlink activity over time that impact at least one of SEC) effectiveness and relative SEO performance of at least one target marketing enterprises.

Technologies described herein generally include methods of analyzing backlinks. An example of such a method may include monitoring a plurality of backlinks over a predetermined period of time, the backlinks associated with at least one entity of interest, analyzing the plurality of backlinks to determine changes in the plurality of backlinks and comparing the changes in the plurality of backlinks over the predetermined period of time to evaluate authenticity of the backlinks.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an embodiment of a system for analyzing changes in backlinks in accordance with technologies described herein;

FIG. 2 illustrates another embodiment of a system for analyzing changes in backlinks in accordance with technologies described herein;

FIG. 3 illustrates an embodiment of a system for monitoring backlink change activities in accordance with the technologies described herein;

FIG. 4 illustrates an embodiment of a system for evaluating backlinks in accordance with the technologies described herein;

FIG. 5 illustrates an embodiment of a system for identifying and evaluating backlinks, as well as analyzing backlink changes, in accordance with the technologies described herein; and

FIG. 6 illustrates an embodiment of a computing device arranged to perform any of the computing methods in accordance with the technologies described herein.

### DETAILED DESCRIPTION

Embodiments described herein include systems and methods for detecting changes in backlink activity of competitors, by use of a systematic comparison over the course of time of actual backlinks to competitors' content and websites. In addition, the combination of such a system with a mechanism that automatically evaluates the backlinks of a competitor to ascertain, group, or otherwise categorize or rank the reasonableness and level of authenticity and actual content value of the backlinks themselves to determine whether such backlinks are likely to be “black hat” backlinks subject to penalization by search engines.

As used herein, the term “backlink” may refer to incoming links to a website or web page. The incoming link may be located on another website and may direct to the website or web page. The link may be any link received by a web node (web page, directory, website, or top level domain) from another web node. Backlinks may also be referred to as “incoming links,” “inbound links,” “inlinks” and “inward links.”

As used herein, the term “black hat backlink” may refer to links created with the intent to manipulate search engine rankings Examples of such black hat backlinks include hidden links.

Marketers who seek visibility using organic (i.e., non-paid search engine optimization (SEO) techniques vie with their competitors to achieve high page rank results on their search terms in part by building “backlinks” to their content and web pages from other web pages. The stronger and more relevant such backlinks, the more likely their content and web pages will have a high rank in the major search engines, such as Google and Bing, and the more likely users of such engines will be directed to their content and web pages. To maintain high search engine rankings for their content and web pages, among other things, marketers need to monitor the backlink activity and strategies of their competitors. This can be a tedious and time-consuming process if not highly automated. Even better would be the ability to monitor, on a frequent (or ideally a real-time or near-real-time) basis, changes in the backlink activity and strategies of competitors. Changes, if properly detected, can be strong signals of important competitive trends. Early detection of such trends, by means of an automated detection system could significantly improve the competitiveness of a marketer's SEO effectiveness. However, to-date, no system has been introduced to automatically track and monitor such backlink activity and calculate, impute, or deduce competitive trends over suitable time periods.

In addition, the internet search industry has in recent years seen rapid growth in so-called “black hat” SEO techniques, such as paid backlinks and low-value backlink “farms” constructed primarily for the purpose of attempting to trick or “game” the major search engines by fabricating backlinks with little or no underlying substantive value other than merely pointing to destination content or websites with the main objective of influencing SEO web results. Such black hat techniques are largely scorned by the major search engines, and indeed, when detected such destination sites are commonly penalized by these same search engines.

Technologies described herein relate generally to an automated system that examines changes in backlinks over time using a digital algorithm that can process large amounts of backlink data across multiple companies in the same or overlapping time periods. Such a system, by making fine-grained and/or frequent comparisons of backlinks associated with internet content or web page, and summarizing the volume changes and changes in the characteristics, types, and/or patterns of such backlinks, to identify competitive behavior and industry trends that impact SEO effectiveness and/or relative SEO performance of one or more target marketing enterprises.

Technologies described herein relate generally to mechanisms to further process and filter the digital output from an automated system such as that described above, using information, data, calculations, rankings, rate of change, types of backlinks created, etc. to draw inferences about the likelihood that certain backlink activity of competitors is based primarily upon genuinely high-value information content in the referred site or primarily upon black hat SEO techniques largely designed to trick or otherwise “game” major internet search engines. Such a system may rank order, categorize, or otherwise group backlinks according to an algorithm that processes information about company backlinks and backlink activity.

Technologies described herein relate generally to presentation of the automated backlink detection system and/or the data processing and filtering mechanisms used to evaluate, rank, categorize, or otherwise group backlinks for presentation to marketers and/or their agents and/or inclusion of such components in either a larger SEO analytic engine or as a standalone service for marketers and their agents.

Technologies described herein relate generally to inclusion of the above components and/or their output and results, singly or in combination, in a “recommendation engine” which provides automated or semi-automated guidance for marketing staff in a company (or their agents) to assist them in devising effective counter-strategies to offset or improve upon competitors' backlink activities and therefore improve their SEO effectiveness.

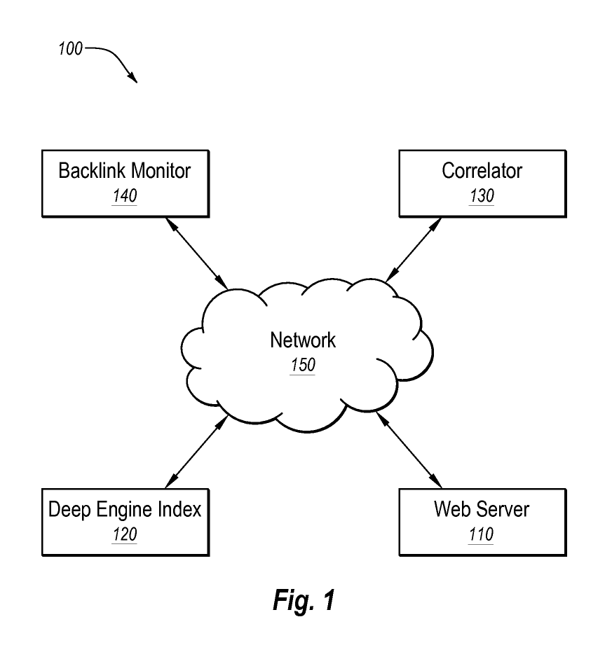

FIG. 1 shows a backlink monitoring system 100, which may include a network 105, a webserver 110, a deep index engine 120, a correlator 130, and a backlink monitor 140. It will be appreciated that while these components are shown as separate; the components may be combined and/or integrated as desired. Further, while one of each component is illustrated, the system 100 may optionally include any number of each of the illustrated components.

The network 105 may be configured to communicatively couple the various components within the system 100 together. In these and other embodiments, the network 105 may include the Internet, including a global internetwork formed by logical and physical connections between multiple wide area networks and/or local area networks. Alternately or additionally, the network 105 includes one or more cellular radio frequency (RF) networks and/or one or more wired and/or wireless networks such as, but not limited to, 802.xx networks, Bluetooth access points, wireless access points, IP-based networks, or the like. The network 105 can also include servers that enable one type of network to interface with another type of network.

The backlink monitor 140 may be configured to determine one or more backlinks and monitor such backlinks over time. The backlinks may be selected from a group or basket of known backlinks that may affect actions related to an entity. The backlink monitor 140 may also be configured to help marketers identify black hat backlinks, and monitor such black hat backlinks over time.

The web server 110 may include any system capable of storing and transmitting a web page to a user. For example, the web server 110 may include a computer program that is responsible for accepting requests from clients (user agents such as web browsers), and serving them HTTP responses along with optional data contents, which can include HTML documents and linked objects for display to the user. Additionally or alternately, the web server 110 may include the capability of logging some detailed information, about client requests and server response, to log files.

The entity can include any number of web pages. The aggregation of references to the various web pages can be referred to as traffic. It should be noted that web page as used herein refers to any online posting, including domains, subdomains, web posts, Uniform Resource Identifiers (“URIs”), Uniform Resource Locators (“URLs”), images, videos, or other piece of content and non-permanent postings such as e-mail and chat unless otherwise specified.

External references to a web page may include any reference to the web page which directs a visitor to the web page. For example, an external reference may include text documents, such as blogs, news items, customer reviews, emails or any other text document which discusses the web page. Alternately or additionally, an external reference can include a web page which includes a link to the web page. For example, an external reference can include other web pages, search engine results pages, advertisements or the like.

In some embodiments, the deep index engine 120 is configured to use identified search terms to perform a search of the network 150 to identify references to the entity. The deep index engine 120 may be further configured to score the results of the search of the network 150 with respect to the entity. This score may include a position at which references to the entity are displayed within the search results. The relative position of the references to the entity within the search results can affect how the references affect actions related to the entity. Accordingly, by determining the relative position of the references to the entity within the search results, the deep index engine 120 may be able to determine a current performance metric for each of the search terms as they relate to the entity.

Alternately or additionally, the deep index engine 120 may be configured to score the search results for each of the search terms with respect to other entities, including entities found in a competitive listing for the search results. The competitive listing may include search results for one or more of the search terms with respect to one or more competitors of the entity. Accordingly, the deep index engine 120 may be configured to gather external data related to performance of other entities to establish current baselines for those entities as well.

Alternately or additionally, the deep index engine 120 may be configured to crawl the search results related to each of the search terms to retrieve external data. In particular, the deep index engine 120 may be configured to crawl the search results for each of the search terms and analyze data associated with the crawl, including on-page information and back link data (e.g., back link URL, anchor text, etc.) for each URL in the search result. The deep index engine 120 may then analyze the data to identify additional search terms that may be relevant to the entity, but which may not have been searched or on which the entity does not rank. In some embodiments, this analysis may include conducting a keyword frequency search. Accordingly, the deep index engine 120 may be configured to surface additional search terms. In some embodiments, these additional search terms and opportunities are identified and targeted in any channel (SEO, paid search, social networks, etc.). Cross-channel opportunities are also a part of the opportunity identification (e.g., if a customer is not ranking on a keyword on organic search that a competitor ranks on, the customer can immediately target this keyword in paid search).

A deep index engine according to some embodiments is described in more detail in copending U.S. patent application Ser. No. 12/436,704 entitled COLLECTING AND SCORING ONLINE REFERENCES, filed May 6, 2009, which application is hereby incorporated by reference in its entirety.

Additional current performance metrics may include internal data determined by the correlator 130. The correlator 130 may determine how visitors are directed to the entity and how those visitors behave once there. For example, the correlator 130 can correlate conversion of visits to the search terms that drove the visits.

A correlator according to some embodiments is described in more detail in copending U.S. patent application Ser. No. 12/574,069, filed Oct. 6, 2009 entitled CORRELATING WEB PAGE VISITS AND CONVERSIONS WITH EXTERNAL REFERENCES, which application is hereby incorporated by reference in its entirety.

The correlator 130 or other component may be configured to collect web analytics data from the entity's web pages. The web analytics data may be used in estimating the cost, value, or both, associated with various SEO opportunities. Examples of web analytics data that may be collected include number of visitors, page views, conversions (e.g., purchases), and the like or any combination thereof.

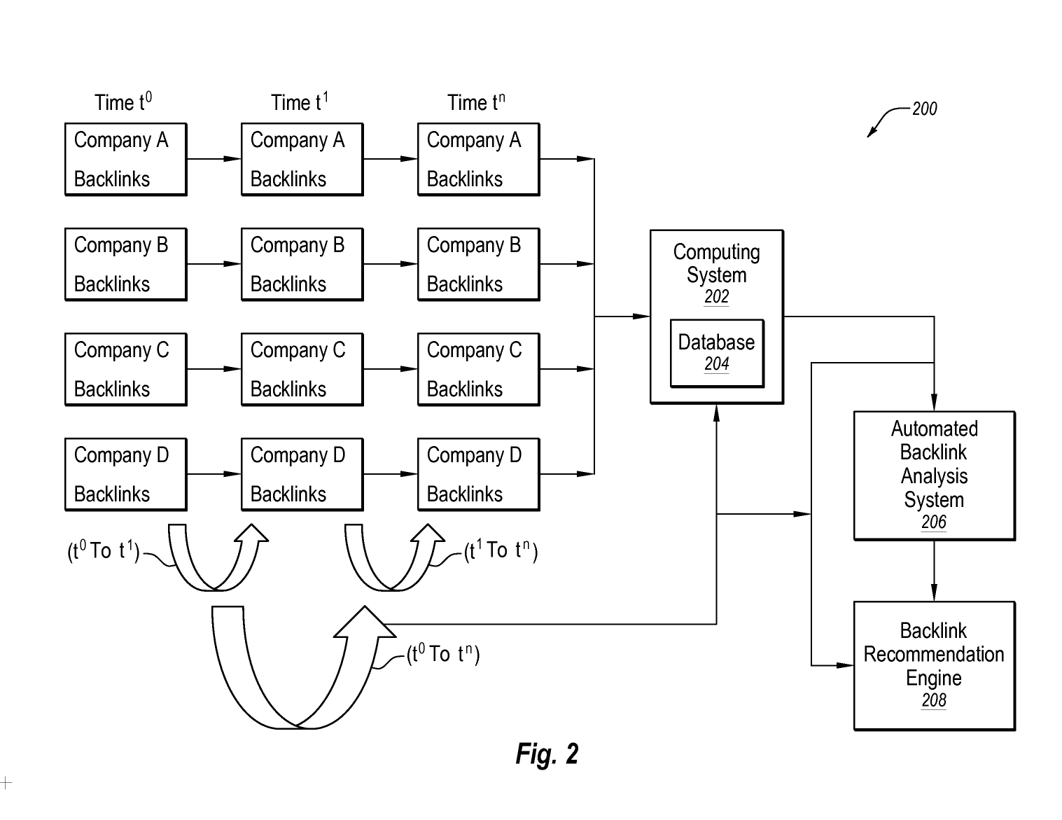

FIG. 2 illustrates another embodiment of a system 200 for analyzing changes in backlinks. As shown in FIG. 2, the system 200 may include a computing system 202 including a database 204, a backlink analysis system 206 and a backlink recommendation engine 208. Any number of backlinks may be associated with each of a plurality of entities, Company A, Company B, Company C and Company D. For example, the backlinks may include any link received by a website or web page associated with one of the entities, which is received from a source, such as a search engine. The database 202 may be configured to monitor backlink activity for the entities, Company A, Company B, Company C and Company D, and to collect and/or store data relating to one or more changes in the backlinks for each of the entities. Such changes in the backlinks may include addition of backlinks, removal or deletion of backlinks, revisions to backlinks, or any other changes in backlinks now known or later developed. For the sake of simplicity, the system 200 of FIG. 2 is illustrated in association with four (4) entities (e.g., Company A, Company B, Company C and Company D) from which backlink data is collected, however, the system 200 described herein may be used to determine changes in backlinks in any number of entities. For example, one or more of Companies A, B, C and D may be a company of interest (e.g., a customer) and the remaining companies may be competitors of the company of interest. Company A, Company B, Company C and Company D may each separately change backlinks from time t⁰ to t¹ to tⁿ, wherein t represents a period of time and wherein n is an integer.

The computing system 202 may be used to monitor the changes in the backlinks over a predetermined period of time (e.g., from time t⁰ to time tⁿ) and to process the changes using an algorithm, such as a backlink change detection algorithm, that generates data related to the changes in the backlinks. For example, the computing system 202 may monitor the changes in backlinks associated with any number of entities (e.g., Company A, Company B, Company C and Company D) over a time period of about one (1) week to about eight (8) weeks and, more particularly, about four (4) weeks, and the changes during the time period may be processed using the algorithm to generate data.

Such data may include, for example, detailed backlink analyses, keywords statistics, traffic statistics, keyword or website trends, keyword or web page ranks, etc. The backlink analyses may include information such as the date and time of visits, etc. The resulting data may be sent to the database 204, which may include a filtering system. The filtering system may be configured to filter the data based on the presence of one or more keywords, selected or popular terms and anchor text. The filtered data is then sent to the automated backlink analysis system 206, which provides recommendations in view of the backlinks via, for example, the backlink recommendation engine 208.

For example, the backlink recommendation engine 208 may be configured to determine behaviors that impact SEO effectiveness and/or relative SEO performance of one or more target marketing enterprises.

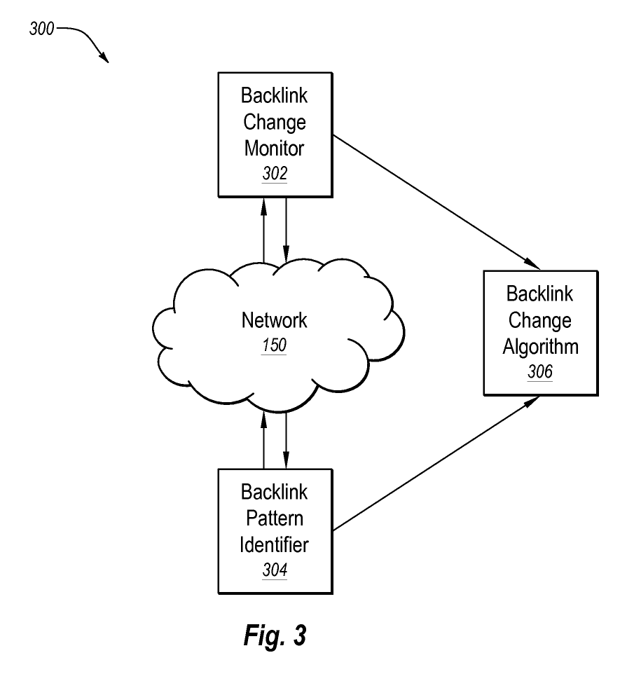

FIG. 3 illustrates an embodiment of a system 300 for monitoring backlink change activities. The system 300 may be configured to analyze backlink changes by processing backlink data. For example, the system 300 may include at least one backlink change module 302 for monitoring changes in backlinks, such as changes in backlink type, changes in backlink characteristics and changes in backlink volume. The system 300 may additionally include a backlink pattern identifier module 304 for identifying and/or recognizing patterns in the backlinks. The system 300 may also include a backlink change algorithm module 306 for analyzing information collected using the backlink change module 302 and the backlink pattern identifier module 304. The system 300 may gather information via the network 150 by way of a web crawler, or other search engine.

The backlink changes may include a change in at least one of a status of the backlinks (e.g., deletion, addition or modification of the backlinks), anchor text, page rank, keywords (e.g., deletion, addition or modification of the keywords) and quality of the backlinks.

As a non-limiting example, the backlink type change may include a change in at least one of the following types of backlinks: raw backlinks, deep backlinks and anchor text backlinks. As another non-limiting example, the backlink type change may include a change in at least one of the following sources of the backlinks: directories, blogs, forums, in context links, press releases and bookmarking. The backlink type change may include, for example, a change from indexable text to text in images and vice versa.

The backlink change module 302 may be configured to monitor changes in backlink characteristics, which may be used to determine the quality or authenticity of backlinks. Such backlinks characteristics may include, for example, the text associated with the link (so-called “link text”), the relevance of the web page on which the link in placed, the page rank of the page where the link is placed, the authority and/or trust of a source webnode. The link text may include a hyperlink or a value of alternative attribute (e.g., an alt attribute) associated with a link. Additionally or alternately, the link text may include one or more keywords or targeted keyword phrases.

The backlink change module 302 may be configured to monitor changes in backlink volume. The backlink volume change may include an assessment of the change in volume or number of backlinks amassed by one or more of the entities.

The backlink pattern identifier module 304 may identify patterns in URLs, article directories, variation in anchor text (e.g., keywords) and keyword density.

The information collected by the backlink change monitor 302 and the backlink pattern identifier 304 may be analyzed using the backlink change algorithm 306. For example, the backlink change algorithm 306 may be configured to determine the quality of the backlinks based on the changes determined by the backlink change monitor 302 and the backlink pattern identifier 304. For example, the analysis may include determining relevance of to search phrases. Such a determination may be made based on one or more keywords from the search phrase found in the content of the web page, emphasis of text or the keywords from the search phrase emphasized (e.g., in bold or italics) and identity of text or the keywords from the search phrase within link text of backlinks.

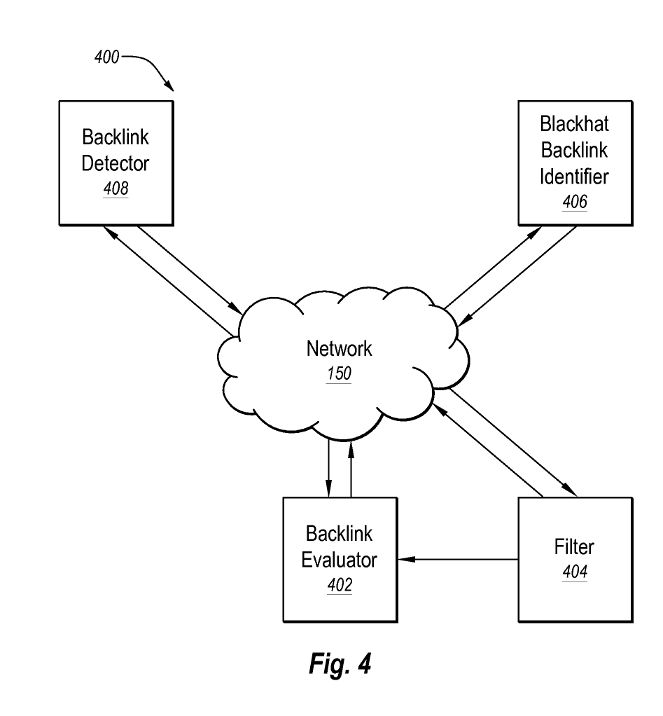

FIG. 4 illustrates an embodiment of an automated system 400 for evaluating backlinks by a backlink evaluator (e.g., evaluator module) 402. The backlink evaluator module 402 may include one or more of the following modules: a backlink grouper module; a backlink categorizer module; a backlink ranker module; a backlink authenticator module; or a backlink web page content analyzer. Thus, the backlink grouper module or the backlink categorization module may group or categorize the backlinks by, for example, keyword, domain, relevance, authenticity, or other factors. As a non-limiting example, the backlink grouper module may group the backlinks and the backlink categorizer module may generate a report, list, table or tree including the categorized backlinks. Such categorization may be useful in link building and search engine optimization. The information generated by the backlink grouper module and the backlink categorizer module may be used by the backlink ranker module, the backlink authenticator module and the backlink web page content analyzer, as will be described.

The backlink ranker module may create a ranking of the backlinks based on predetermined criteria, such as importance of the backlinks. The importance of the backlinks may be determine based on a number of factors, such as, the relatedness of the website to the backlink, the rank of the website and the number of websites linking to a website of interest. As a non-limiting example, the backlinks may be ranked based on the relationship of web pages to one another.

The backlink authenticator module may authenticate the backlinks by, for example, ranking a level of authenticity and/or actual content value of the backlinks. The backlink web page content analyzer may provide information about the content of websites and web pages, which may be used by one or more of the backlink grouper module, the backlink categorizer module, the backlink ranker module, the backlink authenticator module and the backlink web page content analyzer.

The system 400 may include a filter 404 configured to filter automated digital output from the network and/or the backlink evaluator. For example, the filter 404 may include filter backlink data obtained from the network 150 and/or may data output from the backlink evaluator module 402. For example, the filter 404 may use information such as rankings, rate of change and backlink type to determine if the backlinks are of high-value information content. The filter 404 may then remove backlinks determined not to provide high-value information content from determinations.

The system 400 may optionally include a black hat backlink identifier module 406 configured to identify black hat backlinks. For example, the black hat link identifier module 406 may analyze backlink data to identify black hat backlinks as outsourced links, paid links, farmed links, etc. The system 400 may then evaluate black hat data to evaluate, rank, categorize, or otherwise group the backlinks and provide data relating to the black hat backlink to the search engine associated with the network 150. Such data relating to the black hat backlinks may also be provided as marketing information to, for example, a marketing agent, a marketing firm, etc. The black hat backlink identifier 406 may determine content not consistent with the website and may also determine backlinks with low relevance. Thus, the system 400 provides automated or semi-automated black hat backlink data. At least one of the black hat backlink identifier 408 and the backlink evaluator module 402 may be configured to determine one or more strategies or counters to offset such black hat backlinks.

Optionally, the system 400 may include a backlink detector 408, which may be configured to detect backlinks using the network 150. For example, the backlink detector 408 may detect backlinks identified by one or more search engines using the network 150. For example, the backlink detector 404 may employ a web crawler or other search engine to detect the backlinks of the entity or of one or more competitors of the entity. The backlink detector 408 may optionally include a competitor backlink detector module for use in determining backlinks of the competitors. One or more of the components of the system 400 may be configured to obtain information via the network 150, and may be communicatively coupled to one or more other components of the system 400 via the network 150.

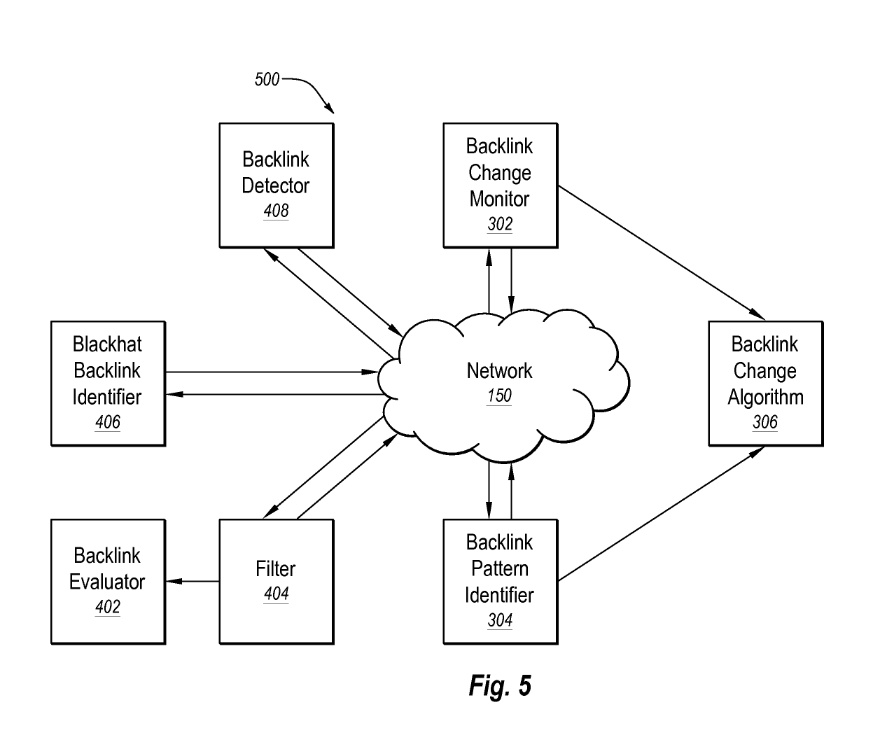

FIG. 5 shows a robust automated system 500 for identifying and evaluating backlinks, as well as analyzing backlink changes. The system 500 may include the backlink change monitor 302, the backlink pattern identifier 304, the backlink change algorithm 306, as described with respect to FIG. 3, and the backlink evaluator 402, the filter 404, the black hat backlink identifier 406, the backlink detector 408, as described with respect to FIG. 4. One or more of the components of the system 500 may be communicatively coupled to one another via the network 150. The system 500 may obtain information related to the backlinks via the network 150.

Such components may gather data related to the backlink activity over the predetermined period of time and may communicate with one another over the network 105.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. It should also be recognized that any module or component described herein can implement the functionalities associated with the name of the module or component.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.). Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

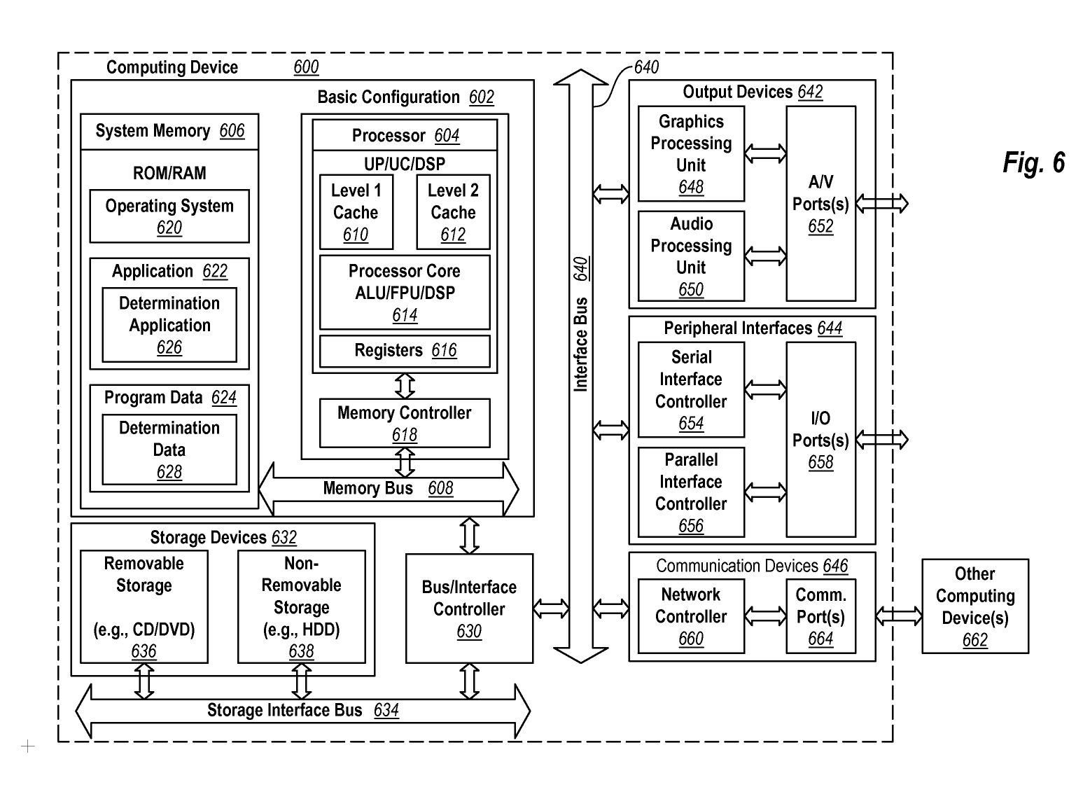

FIG. 6 shows an example computing device 600 that is arranged to perform any of the computing methods described herein. The computing system 600 can represent a user side computing device, such as a mobile smart phone, as well as an application marketplace search facilitating server, arranged in accordance with at least some embodiments described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, RF, microwave, infrared (IR) and other wireless media. The term computer readable media as used herein may include both storage media and communication media. Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above.

Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

What is claimed is:

1. An automated system for analyzing changes in backlinks over time and comprising computer-executable instructions for performing a computing method, the computing method comprising:
examining changes in at least one backlink over a predetermined period of time;
processing changes in the at least one backlink over time using an algorithm configured to process large amounts of backlink data across multiple companies in the predetermined period of time; and
identifying changes in backlink activity over time that impact at least one of SEO effectiveness and relative SEO performance of at least one target marketing enterprises.

2. The automated system of claim 1, wherein the automated system is configured to make at least one of refined frequent comparisons of backlinks associated with internet content or a web page.

3. The automated system of claim 1, wherein identifying backlink change behavior that impact at least one of SEO effectiveness and relative SEO performance comprises summarizing volume changes to identify competitive behavior and industry trends that impact the at least one of SEO effectiveness and relative SEO performance.

4. The automated system of claim 1, wherein identifying backlink change behavior that impact at least one of SEO effectiveness and relative SEO performance comprises summarizing changes in at least of characteristics, types, and patterns of the one or more backlinks.

5. The automated system of claim 1, further comprising at least one of a backlink detector module, a competitor backlink detector module, a backlink change monitoring module, a backlink evaluator module, a genuine backlink identifier module, a black hat backlink identifier module, and a digital output filter module.

6. The automated system of claim 5, further comprising at least one of a backlink change algorithm module, backlink volume change algorithm module, backlink characteristic algorithm change module, backlink type change algorithm module, a backlink grouper algorithm module, a backlink categorizer algorithm module, a backlink ranker algorithm module, a backlink authenticator algorithm module, and a backlink web page content analyzer algorithm module.

7. The automated system of claim 1, further comprising a module comprising at least of hardware and software to configured to implement module function the module being configured to:
perform at least one of processing and filtering of digital output from the automated system; and
use information, data, calculations, rankings, rate of change and types of backlinks to determine if backlink activity of at least one competitor is based on high-value information content or on black hat backlinks.

8. The automated system of claim 7, wherein the automated system is configured to determine if at least one of the black hat backlinks is configured to trick an internet search engine.

9. The automated system of claim 1, wherein the automated system is configured to rank, order, categorize, or otherwise group backlinks according to an algorithm that processes information about company backlinks and backlink activity.

10. The automated system of claim 1, further comprising identifying a backlink as a black hat backlink.

11. The automated system of claim 1, wherein the automated system is configured to provide a list of one or more black hat backlinks to an internet search engine.

12. A method of analyzing backlinks, comprising:
monitoring a plurality of backlinks over a predetermined period of time, the backlinks associated with at least one entity of interest;
analyzing the plurality of backlinks to determine changes in the plurality of backlinks; and
comparing the changes in the plurality of backlinks over the predetermined period of time to evaluate authenticity of the backlinks.

13. The method of claim 12, wherein monitoring a plurality of backlinks comprises monitoring the plurality of backlinks to at least one of web-based content and websites.

14. The method of claim 12, wherein comparing the changes in the plurality of backlinks over the predetermined period of time comprises comparing the changes in at least one of backlink type, backlink characteristics, and backlink volume.

15. The method of claim 12, wherein comparing the changes in the plurality of backlinks over the predetermined period of time to evaluate authenticity of the backlinks comprising determining a black hat backlink.

16. The method of claim 15, further comprising generating at least one report comprising the black hat backlinks.

17. The method of claim 15, further determining at least one counter to improve backlink activities.
